(19) United States
(12) Patent Application Publication
(10) Pub. No.: US 2022/0312732 A1
(43) Pub. Date: Oct. 6, 2022

(54) ANIMAL GARMENT AND ANIMAL BIOLOGICAL INFORMATION MEASUREMENT APPARATUS

(71) Applicants: TOYOBO CO., LTD., Osaka (JP); TOYOBO STC CO., LTD., Osaka (JP)

(72) Inventors: Yoko KOMATSU, Shiga (JP); Hitoshi NISHIMURA, Osaka (JP); Daichi YAMAMOTO, Osaka (JP); Shohei TOCHINO, Osaka (JP); Masahiro KOBAYASHI, Shiga (JP); Nobuhiro KURODA, Osaka (JP); Hiroyuki MORII, Osaka (JP); Yuichiro OMOTE, Osaka (JP); Hideki KAWABATA, Osaka (JP)

(73) Assignees: TOYOBO CO., LTD., Osaka (JP); TOYOBO STC CO., LTD., Osaka (JP)

(21) Appl. No.: 17/614,108

(22) PCT Filed: May 15, 2020
(86) PCT No.: PCT/JP2020/019508

§ 371 Date: Nov. 24, 2021

(30) Foreign Application Priority Data
May 27, 2019 (JP) 2019-098621

(51) Int. Cl. A01K 13/00; A01N 25/34; A01N 59/16; A01P 3/00

(52) U.S. Cl. CPC A01K 13/006; A01N 25/34; A01N 59/16; A01P 3/00

(57) ABSTRACT

The purpose of the present invention is to provide an animal garment and an animal biological information measurement apparatus that are excellently comfortable. The animal garment includes a knitted fabric,
the knitted fabric containing 2 mass % or more and 100 mass % or less of antifungal fibers, and 30 mass % or more and 100 mass % or less of fibers having a single fiber fineness of 0.3 dtex or more and 1.1 dtex or less.

### TECHNICAL FIELD

The present invention relates to an animal garment including a knitted fabric.

### BACKGROUND ART

In recent years, a demand for putting garments on an animal is increasing from the viewpoint of, for example, protecting the animal from cold, preventing the animal from getting the hairs thereof dirty, and improving the fashionability, and various types of animal garments have been developed. For example, in Patent Document 1, a pet wear including, in at least a part on the rear side of a body covering portion and a front leg covering portion, a lining formed with deodorized and antibacterial mesh is disclosed.

### RELATED ART DOCUMENT

### Patent Document

Patent Document 1: JP-A-2001-333655

### SUMMARY OF THE INVENTION

### Problem to be Solved by the Invention

Deodorized and antibacterial pet wear and the like such as in Patent Document 1 have been known so far, and garments that are further comfortable to animals are desired to be developed. The present invention has been made in view of the above circumstances, and an object of the present invention is to provide an animal garment and an animal biological information measurement apparatus that are excellently comfortable.

### Solutions to the Problem

An animal garment and an animal biological information measurement apparatus according to the present invention that have solved the problem have the following configurations.

[1] An animal garment including a knitted fabric,

the knitted fabric containing 2 mass % or more and 100 mass % or less of antifungal fibers, and 30 mass % or more and 100 mass % or less of fibers having a single fiber fineness of 0.3 dtex or more and 1.1 dtex or less.

[2] The animal garment according to above [1], wherein the knitted fabric has an antifungal activity (L) against Malassezia of 2.0 or more, the antifungal activity (L) being obtained by a following equation (1) based on ISO 13629-2: 2014:

antifungal activity (L)=(log Cₜ−log C₀)−(log Tₜ−log T₀) (1)

wherein log Cₜ represents a common logarithm of a viable count of fungi on a control fabric after 48-hour cultivation, log C₀ represents a common logarithm of a viable count of fungi on a control fabric directly after inoculation, log Tₜ represents a common logarithm of a viable count of fungi on the knitted fabric after 48-hour cultivation, and log T₀ represents a common logarithm of a viable count of fungi on the knitted fabric directly after inoculation.

[3] The animal garment according to above [1] or [2], wherein

the antifungal fibers are silver-containing fibers, and

the knitted fabric contains 2 mass % or more and 40 mass % or less of the silver-containing fibers.

[4] The animal garment according to above [3], having a content of silver contained in the silver-containing fibers of 0.01 parts by mass or more and 10 parts by mass or less relative to 100 parts by mass of the silver-containing fibers.

[5] The animal garment according to any one of above [1] to [4], wherein

the knitted fabric contains 30 mass % or more and 95 mass % or less of cellulose-based fibers.

[6] The animal garment according to any one of above [1] to [5], wherein

the knitted fabric has a moisture percentage in an environment of 25° C. and 60% RH of 3% or more and 15% or less.

[7] The animal garment according to any one of above [1] to [6], wherein

the knitted fabric has a wale density of a skin-side surface of 30 wales/2.54 cm or more and 60 wales/2.54 cm or less.

[8] The animal garment according to any one of above [1] to [7], wherein

the knitted fabric has a course density of a skin-side surface of 40 courses/2.54 cm or more and 80 courses/2.54 cm or less.

[9] The animal garment according to any one of above [1] to [8], wherein

the knitted fabric includes spun yarns, and

each of the spun yarns includes the fibers having a single fiber fineness of 0.3 dtex or more and 1.1 dtex or less.

[10] The animal garment according to any one of above [1] to [9], wherein

the knitted fabric contains 2 mass % or more and 20 mass % or less of elastic yarns.

[11] The animal garment according to any one of above [1] to [10], wherein

the knitted fabric has, under a maximum load of 50 gf/cm, a tensile elongation in a body length direction or a body width direction of 10% or more and 150% or less.

[12] An animal biological information measurement apparatus including:

the animal garment according to any one of above [1] to [11]; and

a biological information measurement electrode provided on the animal garment.

### Effects of the Invention

According to the present invention, the configurations described above enable provision of an animal garment that easily prevents development of Malassezia dermatitis or worsening of Malassezia dermatitis and that is excellently comfortable.

### BRIEF DESCRIPTION OF THE DRAWINGS

FIG. 1 is a developed view on an inner surface (a surface in contact with a living body) of an animal biological information measurement apparatus.

FIG. 2 is a developed view on an outer surface (a surface in no contact with a living body) of the animal biological information measurement apparatus.

FIG. 3 is a view of the animal biological information measurement apparatus put on a dog.

### MODE FOR CARRYING OUT THE INVENTION

An animal garment according to the present invention includes a knitted fabric, the knitted fabric containing 2 mass % or more and 100 mass % or less of antifungal fibers, and 30 mass % or more and 100 mass % or less of fibers having a single fiber fineness of 0.3 dtex or more and 1.1 dtex or less.

With the configurations described above, an animal garment can be provided that easily prevents development of Malassezia dermatitis or worsening of Malassezia dermatitis and that is excellently comfortable. In detail, it has been known that fungus Malassezia that is always present on the skin of animals such as a dog excessively grows in, for example, a high-humidity environment and thus causes Malassezia dermatitis. Therefore, there has been a possibility that an animal in garments is easily steamed and thus develops or easily worsens Malassezia dermatitis. Therefore, the inventors of the present invention have conducted an earnest study and as a result found that a garment containing a prescribed amount of antifungal fibers, particularly silver-containing antifungal fibers can easily suppress the growth of Malassezia. The inventors have further found that a garment that is formed with a knitted fabric and contains a prescribed amount of ultrafine fibers having a single fiber fineness of 0.3 dtex or more and 1.1 dtex or less can have soft and swollen texture, and can reduce surface friction and thus reduce worsening of an area of Malassezia dermatitis or the like. Such garment is comfortable to animals. Hereinafter, each of the configurations of the animal garment according to the present invention is described in detail.

The animal garment includes a knitted fabric. That is, at least a part of the animal garment is formed of the knitted fabric. The knitted fabric is, for example, preferably a weft knitted fabric or a warp knitted fabric, more preferably a weft knitted fabric. The weft knitted fabric includes a circular knitted fabric.

Examples of the weft knitted fabric (circular knitted fabric) include fabrics having stitch structures such as jersey stitch (plain stitch), bare jersey stitch, welt jersey stitch, fraise stitch (rib stitch), purl stitch, half tubular stitch, interlock stitch, tuck stitch, float stich, half cardigan stitch, lace stitch, and plating stitch. Among these examples, jersey stitch, bare jersey stitch, fraise stich, or interlock stich is preferable, and bare jersey stich or interlock stich is more preferable. These stitch structures give a flat structure at least on one surface of the knitted fabric, and therefore enable the knitted fabric to have a smooth hand feeling and thus to gently contact with an affected area. The bare jersey stitch is particularly preferable because it gives the knitted fabric excellent stretchability, and enables the knitted fabric to easily follow the movement of the body of an animal and to thus reduce burden on the skin.

Examples of the warp knitted fabric include fabrics having stitch structures such as single denbigh stitch, open-loop denbigh stitch, single atlas stitch, double cord stitch, half stitch, half base stitch, satin stitch, tricot stitch, half tricot stitch, raschel stitch, and jacquard stitch.

The knitted fabric contains 30 mass % or more and 100 mass % or less of fibers having a single fiber fineness of 0.3 dtex or more and 1.1 dtex or less (hereinafter, sometimes simply called ultrafine fibers). The knitted fabric containing 30 mass % or more of the ultrafine fibers can easily reduce friction force on a skin-side surface thereof. Further, the knitted fabric having such a content of the ultrafine fibers easily has soft and swollen texture and thus has stuffed toy-like touch, enabling an easy improvement of a comforting effect when a pet owner holds his or her pet. For this reason, the knitted fabric has a content of the ultrafine fibers of preferably 40 mass % or more, more preferably 60 mass % or more, further preferably 70 mass % or more, further more preferably 80 mass % or more. On the other hand, the upper limit of the content of the ultrafine fibers is not particularly limited, but may be, for example, 98 mass % or less, or 95 mass % or less.

Usable as the ultrafine fibers are natural fibers, synthetic fibers, regenerated fibers, semisynthetic fibers, and the like. Examples of the natural fibers include cotton, hemp, wool, and silk. The natural fibers may be used directly or after a post treatment such as a hydrophilic treatment or a soil-resistance treatment. Examples of the synthetic fibers include acrylic, polyesters such as polyethylene terephthalate, polyethylene naphthalate, and polylactic acid; and polyamides such as nylon 6 and nylon 66. Examples of the regenerated fibers include rayon, Lyocell, and cupra. Examples of the semisynthetic fibers include acetate. These types of fibers may be used singly, or two or more types thereof may be used. Among these examples, a combination of the synthetic fibers with the regenerated fibers or the semisynthetic fibers can easily give the knitted fabric soft and swollen texture and can further improve the moisture absorbency of the knitted fabric. Therefore, a combination of the synthetic fibers with the regenerated fibers or a combination of the synthetic fibers with the semisynthetic fibers is preferable, and a combination of the synthetic fibers with the regenerated fibers is more preferable. The ultrafine fibers may be provided with an antifungal property, or may include antifungal fibers described later.

The knitted fabric contains 2 mass % or more and 100 mass % or less of antifungal fibers. The knitted fabric containing 2 mass % or more of the antifungal fibers easily exhibits the antifungal property and can thus easily prevent an animal from developing dermatitis. For this reason, the knitted fabric has a content of the antifungal fibers of preferably 3 mass % or more, more preferably 4 mass % or more. On the other hand, reducing the content of the antifungal fibers to a certain level can make it difficult for an animal to prevent development of allergic reaction to the antifungal substance. For this reason, the knitted fabric has a content of the antifungal fibers of preferably 80 mass % or less, more preferably 60 mass % or less, further preferably 40 mass % or less, further more preferably 20 mass % or less, particularly preferably 15 mass % or less.

The antifungal fibers preferably include an antifungal substance. Examples of the antifungal fibers including an antifungal substance include fibers obtained by kneading an antifungal substance in resin, fibers formed of a polymer into which an antifungal substance is introduced, and fibers holding an antifungal substance on the surfaces thereof. Among these examples, fibers holding an antifungal substance on the surfaces thereof are preferable because they easily exhibit the antifungal property. Examples of the antifungal substance include organic antifungal substances such as a quaternary ammonium salt-based compound, a triazole-based compound, and an imidazole-based compound; and inorganic antifungal substances such as a noble metal (e.g., silver, zinc, and copper) and a metal salt thereof, and zeolite carrying metal ions (e.g., a silver ion, a zinc ion, and a copper ion). These types of substances may be used singly, or two or more types thereof may be used. Among these examples, a noble metal is preferable because it has an excellent effect of suppressing the growth of Malassezia, and silver, a silver salt, and a silver ion are more preferable.

Commercially available fibers may be used as the antifungal fibers, but as a method for making fibers hold a noble metal, for example, JP-A-H07-243169, JP-A-H09-13221, and the like can be referred to. The antifungal fibers obtained by these methods easily maintain the antifungal property even after repetitive washing, because noble metal ions are firmly bonded to the fibers by ionic bonds. As a method for introducing a quaternary ammonium base into a polymer of fibers, JP-B-S58-10510 can be referred to.

As a material for the antifungal fibers, the materials for the ultrafine fibers can be referred to. Among those materials, the synthetic fibers or the regenerated fibers are preferable as noble metal-containing fibers, the synthetic fibers are more preferable, and acrylic fibers are further more preferable.

The antifungal fibers preferably have a single fiber fineness of more than 1.1 dtex and 2.5 dtex or less. The antifungal fibers having a single fiber fineness of more than 1.1 dtex can easily have improved strength. The antifungal fibers have a single fiber fineness of preferably 1.2 dtex or more, more preferably 1.3 dtex or more, further preferably 1.4 dtex or more. On the other hand, the antifungal fibers having a single fiber fineness of 2.5 dtex or less can easily exhibit the antifungal property. The antifungal fibers have a single fiber fineness of preferably 2.2 dtex or less, more preferably 2.0 dtex or less, further preferably 1.8 dtex or less.

When the antifungal fibers are silver-containing fibers, the knitted fabric preferably contains 2 mass % or more and 40 mass % or less of the silver-containing fibers. The knitted fabric having a content of the silver containing fibers of 2 mass % or more can easily suppress the growth of Malassezia. The knitted fabric has a content of the silver-containing fibers of more preferably 3 mass % or more, further preferably 4 mass % or more. On the other hand, the knitted fabric having a content of the silver-containing fibers of 40 mass % or less enables an animal to be less likely to develop allergic reaction to silver. For this reason, the knitted fabric has a content of the silver-containing fibers of more preferably 30 mass % or less, further preferably 20 mass % or less, further more preferably 15 mass % or less, particularly preferably 8 mass % or less.

The knitted fabric preferably has a content of silver contained in the silver-containing fibers of 0.01 parts by mass or more and 10 parts by mass or less relative to 100 parts by mass of the silver-containing fibers. The knitted fabric having a content of silver of 0.01 parts by mass or more can easily suppress the growth of Malassezia. For this reason, the knitted fabric has a content of silver of more preferably 0.05 parts by mass or more, further preferably 0.10 parts by mass or more, further more preferably 0.15 parts by mass or more. On the other hand, the knitted fabric having a content of silver of 10 parts by mass or less enables an animal to be less likely to develop allergic reaction to silver. For this reason, the knitted fabric has a content of silver of more preferably 5 parts by mass or less, further preferably 1 part by mass or less, further more preferably 0.50 parts by mass or less, particularly preferably 0.40 parts by mass or less.

The content of silver in the antifungal fibers can be obtained, for example, by wet-digesting 0.1 gr of the antifungal fibers with a 95% solution of concentrated sulfuric acid and a 62% solution of concentrated nitric acid, and measuring the atomic absorbance of the resulting solution using atomic absorption spectrometer AA855 manufactured by Nippon Jarrell-Ash Co., Ltd.

When the antifungal fibers are fibers containing a quaternary ammonium salt-based compound, the knitted fabric preferably has a content of the quaternary ammonium salt-based compound contained in the fibers of 0.01 parts by mass or more and 10 parts by mass or less relative to 100 parts by mass of the fibers. The knitted fabric having a content of the quaternary ammonium salt-based compound of 0.01 parts by mass or more can easily suppress the growth of Malassezia. For this reason, the knitted fabric has a content of the quaternary ammonium salt-based compound of more preferably 0.05 parts by mass or more, further preferably 0.10 parts by mass or more, further more preferably 0.15 parts by mass or more. On the other hand, the knitted fabric having a content of the quaternary ammonium salt-based compound of 10 parts by mass or less enables an animal to be less likely to develop allergic reaction to the quaternary ammonium salt-based compound. For this reason, the knitted fabric has a content of the quaternary ammonium salt-based compound of more preferably 5 parts by mass or less, further preferably 3 parts by mass or less, further more preferably 2 parts by mass or less.

The knitted fabric preferably has an antifungal activity (L) against Malassezia of 2.0 or more, the antifungal activity (L) being obtained by a following equation (1) based on ISO 13629-2: 2014.

antifungal activity (L)=(log Cₜ−log C₀)−(log Tₜ−log T₀) (1)

(In the equation, log Cₜ represents a common logarithm of a viable count of fungi on a control fabric after 48-hour cultivation. log C₀ represents a common logarithm of a viable count of fungi on a control fabric directly after inoculation. log Tₜ represents a common logarithm of a viable count of fungi on the knitted fabric after 48-hour cultivation. log T₀ represents a common logarithm of a viable count of fungi on the knitted fabric directly after inoculation.)

The knitted fabric having an antifungal activity (L) of 2.0 or more can easily prevent development or worsening of Malassezia dermatitis. The knitted fabric has an antifungal activity (L) of more preferably 2.1 or more, further preferably 2.2 or more, further more preferably 2.3 or more. On the other hand, the upper limit of the antifungal activity (L) is not particularly limited, but may be, for example, 5.0 or less, or 4.0 or less. The antifungal activity (L) can be measured by the method specifically described later in EXAMPLES.

The knitted fabric preferably has an antifungal activity (L) after 30-time washing based on the 103 method in JIS L 0217 (1995) of 1.8 or more. Such a knitted fabric can easily maintain the effect of preventing development or worsening of Malassezia dermatitis even when washed repetitively. The knitted fabric has an antifungal activity (L) of more preferably 2.0 or more, further preferably 2.2 or more. On the other hand, the upper limit is not particularly limited, but may be, for example, 3.5 or less, or 3.0 or less.

The knitted fabric preferably contains 30 mass % or more and 95 mass % or less of cellulose-based fibers. The knitted fabric containing 30 mass % or more of the cellulose-based fibers improves the moisture absorbency and enables the garment to easily maintain appropriate humidity therein. As a result, it is possible to easily suppress, for example, a steamed feeling, stickiness, and development or worsening of dermatitis. The knitted fabric has a content of the cellulose-based fibers of more preferably 35 mass % or more, further preferably 40 mass % or more. On the other hand, the knitted fabric having a content of the cellulose-based fibers of 95 mass % or less can easily prevent generation of creases and shrinkage of the garment. For this reason, the knitted fabric has a content of the cellulose-based fibers of more preferably 85 mass % or less, further preferably 70 mass % or less, further more preferably 60 mass % or less, particularly preferably 55 mass % or less.

Examples of the cellulose-based fibers include natural cellulose-based fibers such as cotton and hemp; regenerated cellulose fibers such as viscose rayon, polynosic, high wet modulus rayon, Lyocell, and cupra; and semisynthetic cellulose fibers such as acetate. These types of fibers may be used singly, or two or more types thereof may be used. Among these examples, regenerated cellulose fibers are preferable because they have moisture absorbency and easily enable the knitted fabric to realize silk-like texture and hand feeling, and polynosic (for example, Tufcel (registered trade name) manufactured by TOYOBO CO., LTD.), high wet modulus rayon (for example, Modal (registered trade name) manufactured by Lenzing AG), and the like are more preferable.

The knitted fabric preferably has a moisture percentage in an environment of 20° C. and 65% RH of 3% or more and 15% or less. The knitted fabric having a moisture percentage in the above range has a good balance between the moisture absorbency and dryness and thus allows the garment to easily maintain appropriate humidity therein. As a result, it is possible to easily suppress, for example, development or worsening of dermatitis. The knitted fabric has a moisture percentage of more preferably 4% or more and 10% or less, further preferably 5% or more and 7% or less. The moisture percentage can be obtained on the basis of 8.10 of JIS L1096 (2010), with an environment of 20° C. and 65% RH used as an environment before drying.

The knitted fabric has a wale density of a skin-side surface of 30 wales/2.54 cm or more and 60 wales/2.54 cm or less. As the wale density is increased, the knitted fabric has a higher loop density and thus easily has a dense and less uneven surface structure, so that the knitted fabric can easily have a smooth hand feeling. For this reason, the knitted fabric has a wale density of more preferably 35 wales/2.54 cm or more, further preferably 40 wales/2.54 cm or more. On the other hand, the knitted fabric having a wale density of 60 wales/2.54 cm or less can easily improve the breathability. For this reason, the knitted fabric has a wale density of more preferably 55 wales/2.54 cm or less, further preferably 53 wales/2.54 cm or less.

The knitted fabric preferably has a course density of a skin-side surface of 40 courses/2.54 cm or more and 80 courses/2.54 cm or less. As the course density is increased, the knitted fabric has a higher loop density and thus easily has a dense and less uneven surface structure, so that the knitted fabric can easily have a smooth hand feeling. For this reason, the knitted fabric has a course density of more preferably 50 courses/2.54 cm or more, further preferably 55 courses/2.54 cm or more. On the other hand, the knitted fabric having a course density of 80 courses/2.54 cm or less can easily improve the breathability. For this reason, the knitted fabric has a course density of more preferably 78 courses/2.54 cm or less, further preferably 75 courses/2.54 cm or less.

The knitted fabric preferably includes spun yarns. When each of the spun yarns includes ultrafine fibers, the effect of the ultrafine fibers can easily be exhibited. In the meantime, when each of the spun yarns includes antifungal fibers, the effect of the antifungal fibers can easily be maintained. For this reason, the knitted fabric (100 mass %) has a content of the spun yarns of preferably 60 mass % or more, more preferably 80 mass % or more, further preferably 90 mass % or more. The upper limit of the content of the spun yarns is not particularly limited, but may be, for example, 98 mass % or less, 95 mass % or less, or 93 mass % or less.

Each of the spun yarns preferably includes the above-described ultrafine fibers (the fibers having a single fiber fineness of 0.3 dtex or more and 1.1 dtex or less). The ultrafine fibers included in the spun yarns enable the knitted fabric to easily exhibit the effect of reducing the friction force and the effect of, for example, improving the softness that are attributed to the ultrafine fibers. For this reason, the spun yarns (100 parts by mass) have a content of the ultrafine fibers of preferably 40 parts by mass or more, more preferably 60 parts by mass or more, further preferably 70 parts by mass or more, further more preferably 85 parts by mass or more. On the other hand, the upper limit of the content of the ultrafine fibers in the spun yarns is not particularly limited, but may be, for example, 98 parts by mass or less, or 95 parts by mass or less.

Each of the spun yarns preferably includes the above-described antifungal fibers. The antifungal fibers included in the spun yarns allow the knitted fabric to easily maintain the antifungal property. For this reason, the spun yarns (100 parts by mass) have a content of the antifungal fibers of preferably 3 parts by mass or more, more preferably 5 parts by mass or more. On the other hand, reducing the content of the antifungal fibers to a certain level enables an animal to be less likely to develop allergic reaction to the antifungal substance. For this reason, the spun yarns (100 parts by mass) have a content of the antifungal fibers of preferably 80 parts by mass or less, more preferably 60 parts by mass or less, further preferably 40 parts by mass or less, further more preferably 20 parts by mass or less, particularly preferably 15 parts by mass or less.

The spun yarns preferably have an English yarn count ('s/1) of 20 or more and 80 or less. The spun yarns having an English yarn count of 20 or more enable the knitted fabric to improve the softness. For this reason, the spun yarns have an English yarn count of more preferably 30 or more, further preferably 40 or more. On the other hand, the spun yarns having an English yarn count of 80 or less enable the knitted fabric to improve the strength. For this reason, the spun yarns have an English yarn count of more preferably 70 or less, further preferably 60 or less. The English yarn count can be measured by the method described later in EXAMPLES.

These types of spun yarns are not limited to being used singly, but two or more types thereof may be used in combination. Preferred is, for example, a combination of first spun yarns containing antifungal fibers with second spun yarns containing no antifungal fiber, or a combination of first spun yarns containing antifungal fibers with second spun yarns containing antifungal fibers. Between these combination examples, a combination of first spun yarns containing antifungal fibers with second spun yarns containing no antifungal fiber is more preferable because it enables the knitted fabric to exhibit the antifungal property and easily prevent an animal from developing allergic reaction to the antifungal substance.

The knitted fabric preferably contains, relative to 100 parts by mass of the first spun yarns, the second spun yarns in an amount of preferably 70 parts by mass or more and 130 parts by mass or less, more preferably 80 parts by mass or more and 120 parts by mass or less, further preferably 90 parts by mass or more and 110 parts by mass or less.

Each of the first spun yarns preferably includes antifungal fibers and cellulose-based fibers. The cellulose-based fibers having water absorbency and moisture absorbency allow some water to be easily present around the antifungal fibers and thus allow the antifungal fibers to easily exhibit the antifungal property. Each of the first spun yarns preferably contains, relative to 10 parts by mass of the antifungal fibers, the cellulose-based fibers in an amount of preferably 70 parts by mass or more and 95 parts by mass or less, more preferably 80 parts by mass or more and 90 parts by mass or less. On the other hand, each (100 parts by mass) of the second spun yarns preferably contains 70 parts by mass or more of at least one type selected from the group consisting of synthetic fibers and semisynthetic fibers. Each of the second spun yarns contains the at least one type of fibers in an amount of more preferably 80 parts by mass or more, further preferably 90 parts by mass or more, most preferably 100 parts by mass.

In addition, preferred is a combination of first spun yarns containing ultrafine fibers with second spun yarns containing ultrafine fibers, or a combination of first spun yarns containing ultrafine fibers with second spun yarns containing no ultrafine fiber. Between these combination examples, a combination of first spun yarns containing ultrafine fibers with second spun yarns containing ultrafine fibers is more preferable because it allows the knitted fabric to easily improve the soft and swollen texture. Each (100 parts by mass) of the first spun yarns preferably contains the ultrafine fibers in an amount of preferably 70 parts by mass or more and 95 parts by mass or less, more preferably 80 parts by mass or more and 90 parts by mass or less. On the other hand, each (100 parts by mass) of the second spun yarns contains the ultrafine fibers in an amount of preferably 70 parts by mass or more, more preferably 80 parts by mass or more, further preferably 90 parts by mass or more, most preferably 100 parts by mass.

The knitted fabric preferably contains 40 mass % or more of the first spun yarns and the second spun yarns. Such a knitted fabric easily exhibits the effects of the first spun yarns and the second spun yarns. The knitted fabric contains the first spun yarns and the second spun yarns in an amount of more preferably 50 mass % or more, further preferably 60 mass % or more, further more preferably 65 mass % or more. On the other hand, the upper limit is not particularly limited, but may be, for example, 95 mass % or less, 80 mass % or less, or 70 mass % or less.

The knitted fabric preferably contains 2 mass % or more and 20 mass % or less of elastic yarns. The knitted fabric (100 mass %) having a content of the elastic yarns of 2 mass % or more can easily improve the extension percentage and reduce compression of the garment put on, and can therefore easily prevent development or worsening of dermatitis or can easily inhibit an animal that has developed dermatitis from worsening the dermatitis. The knitted fabric has a content of the elastic yarns of more preferably 4 mass % or more, further preferably 5 mass % or more. On the other hand, setting the content of the elastic yarns to 20 mass % or less enables easy knitting and thus improves the productivity. Further, the knitted fabric having such a content of the elastic yarns gives a good fit and enables dimensional changes to be less likely to be generated. The knitted fabric has a content of the elastic yarns of more preferably 15 mass % or less, further preferably 10 mass % or less.

The elastic yarns are yarns having rubber elasticity. As the elastic yarns, both monofilaments and multifilaments can be used. Specific examples of the elastic yarns include polyurethane elastic yarns, polyester-based elastic yarns, polyolefin-based elastic yarns, natural rubber yarns, synthetic rubber yarns, and yarns made of stretchable composite fibers. These types of elastic yarns may be used singly, or two or more types thereof may be used. Among these examples, polyurethane elastic yarns are preferable because they have excellent elasticity, an excellent heat-setting property, excellent chemical resistance, and the like. As the polyurethane elastic yarns, for example, fusion-type polyurethane elastic yarns, bonding polyurethane elastic yarns, and the like can be used.

The knitted fabric preferably has, under a maximum load of 50 gf/cm, a tensile elongation in a body length direction or a body width direction of 10% or more and 150% or less. The knitted fabric having a tensile elongation of 10% or more allows the garment to easily follow the movement of the body of an animal and can thus easily prevent a tight fit caused by a stop of stretch of the knitted fabric. Further, the knitted fabric having such a tensile elongation enables the garment to be easily put on and taken off. The knitted fabric has a tensile elongation of more preferably 30% or more, further preferably 60% or more, further more preferably 80% or more. On the other hand, the knitted fabric having a tensile elongation of 150% or less can easily inhibit the garment from being slipped from an animal moving around. The knitted fabric has a tensile elongation of more preferably 130% or less, further preferably 110% or less, further more preferably 100% or less. The tensile elongation can be measured by the method described later in EXAMPLES.

The knitted fabric preferably has a basis weight of 100 g/m² or more and 250 g/m² or less. The knitted fabric having a basis weight of 100 g/m² or more can easily have improved strength. For this reason, the knitted fabric has a basis weight of more preferably 120 g/m² or more, further preferably 140 g/m² or more. On the other hand, the knitted fabric having a basis weight of 250 g/m² or less can have reduced weight and can easily improve the breathability. For this reason, the knitted fabric has a basis weight of more preferably 240 g/m² or less, further preferably 220 g/m² or less, further more preferably 180 g/m² or less. The basis weight of the knitted fabric can be measured by the method described later in EXAMPLES.

The knitted fabric preferably has, on the skin-side surface thereof, an average friction coefficient of 0.33 or less. The knitted fabric having an average friction coefficient of 0.33 or less can reduce the irritation of the garment to the skin of an animal. Such a knitted fabric can easily inhibit an animal that has developed dermatitis from worsening the dermatitis. For this reason, the knitted fabric has an average friction coefficient of more preferably 0.32 or less, further preferably 0.31 or less, further more preferably 0.30 or less. On the other hand, the lower limit of the average friction coefficient is not particularly limited, but may be, for example, 0.05 or more, or 0.10 or more. The average friction coefficient can be measured by the method described later in EXAMPLES.

Heretofore, the knitted fabric has been described in detail. The garment formed using such knitted fabric has excellent comfortableness and is suitable as animal garment. Further, the knitted fabric may be used alone, but may also be combined with a known textile, form the garment in the shape of layers or the like, and put them on an animal.

The animal garment can be used as, for example, a garment for family pets such as a dog and a cat; a garment for livestock such as a horse, a cow, and a sheep; a garment for favorite pets such as a reptile and an amphibian; or a garment for wild animals. Among these examples, a garment for family pets are preferable, and a garment for dogs are more preferable.

The animal garment can preferably be used as a protection against cold. In addition, the animal garment can also be used for the purpose of preventing, for example, dirt on hairs of an animal, an insect bite, and a scratch made by an animal itself. Further, the animal garment can also be put on an animal that has already developed dermatitis, for the purpose of, for example, preventing the animal from scratching itself or of protecting an inflamed area.

The animal garment is not particularly limited in terms of the form, but covers preferably at least a part of, for example, a breast, a belly, a front leg, a back leg, a neck, and a face of an animal, more preferably at least a part of a breast and a belly.

The present invention also includes an animal biological information measurement apparatus including the animal garment described above and a biological information measurement electrode provided on the animal garment. In addition to the electrode, the animal biological information measurement apparatus may include, as necessary, wiring, a connector such as a snap fastener, an electronic unit, an electronic unit detachable via the connector, or the like. For example, providing two or more electrodes on an inner surface (a surface on the side in contact with the body surface of an animal) of the animal garment enables measurement of a cardiac potential, a myopotential, or the like. Providing a non-contact electrode on the inner surface or an outer surface of the animal garment enables measurement of impedance changes of the body and thus measurement of pulse, breathing, an exercise state, or the like.

Examples of the electrode include a fabric electrode including conductive fibers, and a stretchable electrode formed with a stretchable conductor composition containing, as main components, conductive particles and soft resin. Generally, these electrodes have low moisture permeability, and therefore a peripheral portion of the electrode is a portion that becomes easily steamy. The animal garment according to the present invention, however, includes antifungal fibers and can therefore prevent the pathogenesis of dermatitis.

The present application claims priority based on Japanese Patent Application No. 2019-098621 filed on May 27, 2019. All the contents described in Japanese Patent Application No. 2019-098621 filed on May 27, 2019 are incorporated herein by reference.

### EXAMPLES

Hereinafter, the present invention is more specifically described by way of examples. The present invention, however, is not limited by the following examples, and can be implemented with changes to the examples within a scope in compliance with the intent described above and below, and all the changes are to be encompassed within the technical scope of the present invention.

English yarn count: in accordance with 9.4.2 of JIS L 1095 (2010), the apparent cotton yarn count of the spun yarns was measured and defined as the English yarn count.

Fineness: the single fiber fineness was obtained by measuring the fineness based on corrected mass on the basis of 8.3.1 Method A of JIS L 1013 (2010), defining the resulting fineness as total fineness, and dividing the total fineness by the number of single fibers.

Wale density and course density: the wale density and the course density of the knitted fabric were measured on the basis of the measurement method in 8.6.2 of JIS L 1096 (2010).

Basis weight: in accordance with “Mass per unit area in standard state” specified in 8.3.2 of JIS L 1096 (2010), the basis weight of the knitted fabric was measured.

Moisture percentage: the moisture percentage of the knitted fabric was measured, with the environment temperature and humidity set to 20° C. and 65% RH, on the basis of 8.10 of JIS L 1096 (2010).

Evaluation of antifungal property: an antifungal test was performed using the knitted fabric obtained in each of the following examples and comparative examples in accordance with Textiles-Determination of antifungal activity of textile products-part2: Plate count method 11 Testing procedure 11.1.2 Absorption method of ISO 13629-2: 2014. As a test strain, Malassezia pachydermatis NBRC 10064 was used. The viable count of fungi per 1 mL of a washout solution was obtained directly after the inoculation of the test strain and after cultivation at 30° C. for 48 hours, and the average value of each of the cases was plugged in the following equation (1) to obtain an antifungal activity.

antifungal activity (L)=(log Cₜ−log C₀)−(log Tₜ−log T₀) (1)

(In the equation, log Cₜ represents a common logarithm of a viable count of fungi on a control fabric after 48-hour cultivation. log C₀ represents a common logarithm of a viable count of fungi on a control fabric directly after inoculation. log Tₜ represents a common logarithm of a viable count of fungi on the knitted fabric after 48-hour cultivation. log T₀ represents a common logarithm of a viable count of fungi on the knitted fabric directly after inoculation.)

Further, the antifungal activity was similarly obtained for the knitted fabric obtained in each of the following examples and comparative examples and washed 30 times on the basis of the 103 method in JIS L 0217 (1995).

Deodorizing property: the dog garments formed with the knitted fabric obtained in each of the following examples and comparative examples were put on one Shih-tzu for one week and then evaluated for the smell of Malassezia (unique smell like fermentation smell) on a four-level scale, the Shih-tzu having been affected by Malassezia dermatitis and having the body thereof washed with Quick & Rich Treatment in Shampoo manufactured by Lion Trading Co., Ltd. Specifically, each of the samples which was put on the dog for one week was put in an aluminum bag with a zipper (length below zipper: 260 mm, bag width: 180 mm), 0.5 L of air was further put in the bag, and the bag was left at 20° C. for 24 hours. In an environment of 20° C. and 65% RH, five subjects evaluated the odor of the sample on a four-level scale (0 point: having no odor, 1 point: having a little odor, 2 points: having odor, and 3 points: having strong odor). The average value of the evaluation points of the five subjects was calculated, and the sample having an average value of 0 points or more and less than 0.5 points was evaluated as having no odor (⊙), the sample having an average value of 0.5 points or more and less than 1.5 points was evaluated as having a little odor (◯), the sample having an average value of 1.5 points or more and less than 2.5 points was evaluated as having odor (Δ), and the sample having an average value of 2.5 points or more and 3.0 points or less was evaluated as having strong odor (x).

Average friction coefficient: MIU (average friction coefficient) of the knitted fabric obtained in each of the following examples and comparative examples was measured. The measurement apparatus and the measurement conditions are as follows. The measurement was performed for three samples each of the knitted fabric and the average value of MIU on the skin-side surface was obtained.

Measurement apparatus: friction tester “KES SE SURFACE TESTER” manufactured by KATO TECH CO., LTD.

Environment: 20° C., 65% RH

Static load: 25 gf/cm²

Speed: 1 mm/sec

Friction element: 10-mm square piano wire

Tensile elongation: a test piece in a size of length 15 cm and width 15 cm was sampled from the knitted fabric obtained in each of the following examples and comparative examples, the tensile elongation (EMT) of the test piece was measured using tensile and shear tester (KES-FBI-A) manufactured by KATO TECH CO., LTD., under the conditions of a tensile speed in each of the course direction and the wale direction of 0.2 mm/s and a maximum load of 50 gf/cm, and the average maximum elongation in each of the course direction and the wale direction was obtained. In detail, the length of the test piece under the maximum load was defined as B, and the original length of the test piece was defined as A, and the value obtained from the formula ((B−A)/A)×100 was defined as the tensile elongation (%).

Garment temperature and humidity: the temperature in the garment was measured as an index of warmth felt by a dog which undergoes insensible perspiration and is in the garment, the measurement being performed according to a model evaluation method in consideration of an actual environment in which a dog is in the garment in a temperature-controlled room in winter. Specifically, the temperature and the humidity in the space between a hot plate and the sample were measured using a sweating simulation measurement apparatus (manufactured by TOYOBO CO., LTD.) at a water supply amount of 30 g/m²·h, a hot-plate temperature of 37° C., a distance between the sample and the hot plate of 1 cm, and an environmental temperature and humidity of 20° C. and 30% RH, and with a sweating pattern of 5-minute water supply after 15 minutes from the start of the test. For the below reason, the temperature in the garment according to the above model evaluation method was employed as the index of warmth felt by a dog. First, a dog in the garment is presumed to feel warmer as the temperature in the space between the body of the dog and the garment is higher. Therefore, the inventors of the present invention put the garment on a dog under the conditions of an environmental temperature and humidity of 20° C. and 30% RH and studied using a sweating simulation apparatus test method (skin model test method). As a result, it was confirmed that the period during which the dog took a lying position in front of a panel heater was shorter, that is, the dog felt warmer when the dog was in the garment made of the knitted fabric that made the temperature in the space 30° C. or more after the start of sweating, than when the dog was in the garment made of the knitted fabric that made the temperature in the space less than 30° C.

Comforting feeling: in an environment of 20° C. and 65% RH, the dog garments formed with the knitted fabric obtained in each of the following examples and comparative examples were put on a toy poodle. Thereafter, ten subjects evaluated, on a four-level scale, the comforting feeling when holding the toy poodle. The dog garment that had a good hand feeling and gave much comfort were evaluated as ⊙, the dog garment that gave comfort was evaluated as ◯, the dog garment that gave a little comfort was evaluated as Δ, and the dog garment that gave no comfort was evaluated as x.

Stickiness and steamed feeling: in an environment of 20° C. and 65% RH, the dog garments formed with the knitted fabric obtained in each of the following examples and comparative examples were put on a toy poodle. Thereafter, ten subjects evaluated whether or not there were the stickiness and the steamed feeling, when holding the toy poodle for 15 minutes. The dog garment having the stickiness and/or the steamed feeling was evaluated as “YES”, and the dog garment having no stickiness and no steamed feeling was evaluated as “NO”.

### Example 1

Silver-containing acrylic fibers each of which contained 0.2 mass % of silver, namely AGliza (single fiber fineness: 1.5 dtex, fiber length: 38 mm) manufactured by TOYOBO STC CO., LTD. was mixed with cellulose-based fibers, namely Micro Modal (single fiber fineness: 1.0 dtex, fiber length: 38 mm) manufactured by Modal Lenzing to give carded slivers, slivers, and finally rovings. These rovings were real-twisted using a ring spinning frame at a twist coefficient of 3.5 times/2.54 cm to give spun yarns 1 having an English yarn count of 50 ('s/1).

Similarly, rovings were produced using acrylic fibers, namely UF type (single fiber fineness: 0.5 dtex, fiber length 32 mm) manufactured by Japan Exlan Co., Ltd., and real-twisted to give spun yarns 2 having an English yarn count of 50 ('s/1).

Knitting was performed using the obtained spun yarns 1 and 2 and fusible polyurethane fibers (filament yarns), namely MOBILON (fineness: 22 dtex) manufactured by Nisshinbo Textile Inc., using a positive yarn feeding device-equipped single circular knitting machine manufactured by Precision Fukuhara Works, Ltd., under the condition of a draft ratio of 3.0 times, and in bare jersey stitch. The obtained gray fabric was subjected to common scouring and bleaching and dyed by a reactive dye, and then subjected to a hydrophilic treatment to finish the knitted fabric. The operation was performed such that the content (mass %) of each of the types of fibers was as shown in Table 1, relative to 100 mass % of the knitted fabric.

### Example 2

A knitted fabric was obtained in the same manner as in Example 1 except that acrylic fibers, namely K822 type (single fiber fineness: 1.0 dtex, fiber length: 38 mm) manufactured by Japan Exlan Co., Ltd. was used in place of the acrylic fibers (single fiber fineness: 0.5 dtex) as the material of the spun yarns 2 in Example 1, and that polyurethane fibers, namely OPELON (fineness: 22 dtex) manufactured by TORAY OPELONTEX CO., LTD. was used as the filament yarns, in place of the fusible polyurethane fiber MOBILON (fineness: 22 dtex).

### Example 3

A knitted fabric was obtained in the same manner as in Example 2 except that the content of the silver-containing acrylic fibers and the cellulose-based fiber Micro Modal that are the materials of the spun yarns 1 in Example 2 was set to the content shown in Table 1, and that the acrylic fibers of the spun yarns 2 were changed to Micro Modal.

### Example 4

A knitted fabric was obtained in the same manner as in Example 2 except that acrylic fibers, namely K60 (single fiber fineness: 2.2 dtex, fiber length: 38 mm) manufactured by Japan Exlan Co., Ltd. was used in place of the acrylic fibers (single fiber fineness: 1.0 dtex) as the material of the spun yarns 2 in Example 2.

### Example 5

Knitting was performed using the same spun yarns as the spun yarns 1 in place of the spun yarns 2 in Example 2, using no filament yarn, using a double circular knitting machine, with interlock gauging, and in interlock stitch. This gray fabric was subjected to a common dye process and then finished in the same manner as in Example 1 to give a knitted fabric.

### Example 6

A knitted fabric was finished in the same manner as in Example 2 except that the spun yarns 1 were formed only with the cellulose-based fiber Micro Modal without using the silver-containing acrylic fibers as a material of the spun yarns 1 in Example 2. Further, this knitted fabric was subjected to an antifungal treatment by a padding method with a silicone-based quaternary ammonium salt. Specifically, in order that an antifungal agent (AEM5700 manufactured by Microban) gave 2% owf (chemical agent attachment rate (%) relative to weight of fibers), the chemical agent was imparted while a formulation solution and the drawing rate thereof were adjusted, and then the knitted fabric was dried and heat-treated at 150° C. for 1 minute.

### Comparative Example 1

A knitted fabric was obtained in the same manner as in Example 2 except that the content of the silver-containing acrylic fibers as a material of the spun yarns 1 in Example 2 was set to the content shown in Table 1, that Modal (single fiber fineness: 1.5 dtex, fiber length: 38 mm) was used at the content shown in Table 1, in place of the cellulose-based fiber Micro Modal (single fiber fineness: 1.0 dtex) in the spun yarns 1, and that acrylic fibers, namely K60 (single fiber fineness: 2.2 dtex, fiber length: 38 mm) manufactured by Japan Exlan Co., Ltd. was used in place of the acrylic fibers (single fiber fineness: 1.0 dtex) as the material of the spun yarns 2.

### Comparative Example 2

A knitted fabric was obtained in the same manner as in Example 2 except that the silver-containing acrylic fibers were not used as a material of the spun yarns 1 in Example 2, that acrylic fibers, namely K60 (single fiber fineness: 2.2 dtex, fiber length: 38 mm) was used at the content shown in Table 1, in place of Micro Modal (single fiber fineness: 1.0 dtex) as a material of the spun yarns 1, and that acrylic fibers, namely K60 (single fiber fineness: 2.2 dtex, fiber length: 38 mm) manufactured by Japan Exlan Co., Ltd. was used in place of the acrylic fibers (single fiber fineness: 1.0 dtex) as the material of the spun yarns 2.

Using the knitted fabric obtained above in each of Examples 1 to 6 and Comparative Examples 1 and 2, dog garments were produced. The knitted fabric and the dog garments were evaluated as described above. Tables 1 and 2 show the physical properties and the evaluation results of these knitted fabrics and dog garments.

TABLE 1

| | | | Example 1 | Example2 | Example3 | Example4 |
|---|---|---|---|---|---|---|
| Stitch structure | | | Bare jersey | Bare jersey | Bare jersey | Bare jersey |
| First spun | Cotton yarn count | (’ s/1) | 50 | 50 | 50 | 50 |
| yarn | Content | mass % | 47 | 47 | 47 | 47 |
| | Fiber 1 | Type | Silver- | Silver- | Silver- | Silver- |
| | | | containing | containing | containing | containing |
| | | | acryl | acryl | acryl | acryl |
| | | Content (mass %) | 5 | 5 | 10 | 5 |
| | | Single fiber | 1.5 | 1.5 | 1.5 | 1.5 |
| | | fineness(dtex) | | | | |
| | Fiber 2 | Type | Cellulose-base | Cellulose-base | Cellulose-base | Cellulose-base |
| | | Content (mass %) | 42 | 42 | 37 | 42 |
| | | Single fiber | 1.0 | 1.0 | 1.0 | 1.0 |
| | | fineness (dtex) | | | | |
| Second spun | Cotton yarn count | (’ s/1) | 50 | 50 | 50 | 50 |
| yarn | Content | mass % | 47 | 47 | 47 | 47 |
| | Fiber | Type | Acryl | Acryl | Cellulose-base | Acryl |
| | | Content (mass %) | 47 | 47 | 47 | 47 |
| | | Single fiber | 0.5 | 1.0 | 1.0 | 2.2 |
| | | fineness(dtex) | | | | |
| Filament yarn | | Type | Fusible | Polyurethane | Polyurethane | Polyurethane |
| | | | polyurethane | | | |
| | | Content (mass %) | 6 | 6 | 6 | 6 |
| | | Fineness (T) | 22 | 22 | 22 | 22 |
| Antifungal treatment (post treatment) | | | No | No | No | No |
| Antifungal fiber | | (mass %) | 5 | 5 | 10 | 5 |
| Ultrafine fibers | | (mass %) | 89 | 89 | 89 | 42 |
| (1.1 dtex or less) | | | | | | |
| Cellulose-based fiber | | (mass %) | 42 | 42 | 84 | 42 |
| Course density | | (course/2.54 cm) | 68 | 71 | 71 | 71 |
| Wale density | | (wale/2.54 cm) | 50 | 51 | 50 | 51 |
| Basis weight | | (g/m²) | 160 | 160 | 160 | 160 |
| Antifungal | initial stage | Antifungal activity (L) | 2.3 | 2.3 | >3.3 | 2.4 |
| property | after 30-time | Antifungal activity (L) | 2.2 | 2.1 | 2.6 | 2.1 |
| | washing | | | | | |
| Deodorizing property | | | ◯ | ◯ | ⊚ | ◯ |
| Tensile elongation | | Course direction (%) | 94 | 67 | 53 | 58 |
| of knitted fabric | | Wale direction (%) | 73 | 48 | 37 | 35 |
| KES surface friction | | Average | 0.20 | 0.22 | 0.23 | 0.29 |
| of knitted fabric | | friction coefficient | | | | |
| | | (MIU) | | | | |
| Moisture percentage | | (%) | 5.1 | 5.2 | 9.5 | 5.4 |
| of knitted fabric | | | | | | |
| In garment | | Temperature, | 31.5° C. | 31.5° C. | 31.6° C. | 31.5° C. |
| | | Humidity | 24% RH | 24% RH | 22% RH | 24% RH |
| | | Comforting feeling | ⊚ | ◯ | ◯ | ◯ |
| Sensory evaluation of garment | | Stickiness and steamed | No | No | No | No |
| | | feeling | | | | |

TABLE 2

| | | | | | Comparative | Comparative |
|---|---|---|---|---|---|---|
| | | | Example5 | Example6 | Example1 | Example2 |
| Stitch structure | | | Interlock | Bare jersey | Bare jersey | Bare jersey |
| First spun | Cotton yarn count | (’ s/1) | 40 | 50 | 50 | 50 |
| yarn | Content | mass % | 50 | 47 | 47 | 47 |
| | Fiber 1 | Type | Silver- | — | Silver- | — |
| | | | containing | | containing | |
| | | | acryl | | acryl | |
| | | Content (mass %) | 5.5 | — | 2 | — |
| | | Single fiber | 1.5 | — | 1.5 | — |
| | | fineness(dtex) | | | | |
| | Fiber 2 | Type | Cellulose-base | Cellulose-base | Cellulose-base | Acryl |
| | | Content (mass %) | 44.5 | 47 | 45 | 47 |
| | | Single fiber | 1.0 | 1.0 | 1.5 | 2.2 |
| | | fineness (dtex) | | | | |
| Second spun | Cotton yarn count | (’ s/1) | 40 | 50 | 50 | 50 |
| yarn | Content | mass % | 50 | 47 | 47 | 47 |
| | Fiber | Type | Silver- | Acryl | Acryl | Acryl |
| | | | containing | | | |
| | | | acryl/ | | | |
| | | | Cellulose-base | | | |
| | | Content (mass %) | 5.5/44.5 | 47 | 47 | 47 |
| | | Single fiber | 1.5/1.0 | 1.0 | 2.2 | 2.2 |
| | | fineness(dtex) | | | | |
| Filament yarn | | Type | — | Polyurethane | Polyurethane | Polyurethane |
| | | Content (mass %) | — | 6 | 6 | 6 |
| | | Fineness (T) | — | 22 | 22 | 22 |
| Antifungal treatment (post treatment) | | | No | Yes | No | No |
| | | | | (quaternary | | |
| | | | | ammonium salt) | | |
| Antifungal fiber | | (mass %) | 11 | 100 | 2 | 0 |
| Ultrafine fibers | | (mass %) | 89 | 94 | 0 | 0 |
| (1.1 dtex or less) | | | | | | |
| Cellulose-based fiber | | (mass %) | 89 | 47 | 45 | 0 |
| Course density | | (course/2.54 cm) | 60 | 71 | 72 | 70 |
| Wale density | | (wale/2.54 cm) | 45 | 51 | 50 | 48 |
| Basis weight | | (g/m²) | 200 | 160 | 160 | 160 |
| Antifungal | initial stage | Antifungal activity (L) | >3.3 | 2.1 | 0.6 | 0.2 |
| property | after 30-time | Antifungal activity (L) | 2.4 | 1.6 | 0.4 | 0.1 |
| | washing | | | | | |
| Deodorizing property | | | ⊚ | ◯ | Δ | X |
| Tensile elongation | | Course direction (%) | 23 | 55 | 54 | 55 |
| of knitted fabric | | Wale direction (%) | 12 | 29 | 38 | 32 |
| KES surface friction | | Average | 0.22 | 0.19 | 0.35 | 0.37 |
| of knitted fabric | | friction coefficient | | | | |
| | | (MIU) | | | | |
| Moisture percentage | | (%) | 9.8 | 5.2 | 5.0 | 0.4 |
| of knitted fabric | | | | | | |
| In garment | | Temperature, | 32.0° C. | 31.5° C. | 31.5° C. | 31.7° C. |
| | | Humidity | 19% RH | 24% RH | 23% RH | 30% RH |
| | | Comforting feeling | ◯ | ⊚ | Δ | X |
| Sensory evaluation of garment | | Stickiness and steamed | No | No | No | Yes |
| | | feeling | | | | |

### Example 7

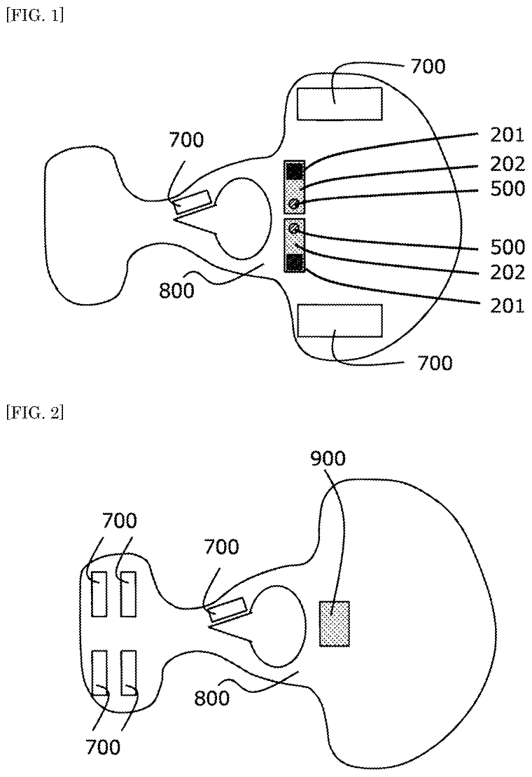

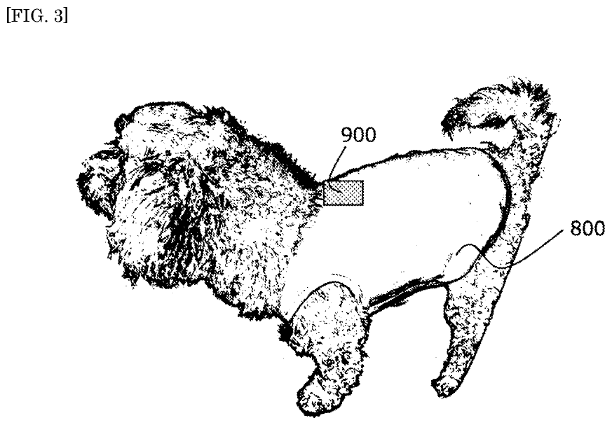

A dog garment was produced using the knitted fabric obtained in Example 1, and a biological information measurement apparatus was produced by attaching an electrode 201, a wiring portion 202, a snap fastener 500 as a connector, a hook and loop fastener 700, and an electronic unit 900 that is a detachable electronic device to a garment main body 800 as illustrated in FIGS. 1 and 2. FIG. 1 is a developed view on an inner surface (a surface in contact with a living body) of the animal biological information measurement apparatus, and FIG. 2 is a developed view on an outer surface (a surface in no contact with a living body) of the animal biological information measurement apparatus. As the electrode 201, an electrode gel, singa gel manufactured by Parker Laboratories Inc. was applied. Further, as the electronic unit 900, WHS-1 manufactured by UNION TOOL CO. was used. Next, as illustrated in FIG. 3, the obtained biological information measurement apparatus was put on a chihuahua (female, 3-year old), and electrocardiographic measurement in daily life was performed. As a result, long-time stable electrocardiographic measurement could be performed. Further, even when the electrocardiographic measurement was continued over one month, a stable measurement result was obtained in that period.

### DESCRIPTION OF REFERENCE SIGNS

201: electrode
202: wiring portion
500: snap fastener
700: hook and loop fastener
800: garment main body
900: electronic unit (detachable electronic device)

1. An animal garment comprising a knitted fabric,
the knitted fabric containing 2 mass % or more and 100 mass % or less of antifungal fibers, and 30 mass % or more and 100 mass % or less of fibers having a single fiber fineness of 0.3 dtex or more and 1.1 dtex or less.

2. The animal garment according to claim 1, wherein
the knitted fabric has an antifungal activity (L) against Malassezia of 2.0 or more, the antifungal activity (L) being obtained by a following equation (1) based on ISO 13629-2: 2014:
antifungal activity (L)=(log Cₜ−log C₀)−(log Tₜ−log T₀) (1)
wherein log Cₜ represents a common logarithm of a viable count of fungi on a control fabric after 48-hour cultivation, log C₀ represents a common logarithm of a viable count of fungi on a control fabric directly after inoculation, log Tₜ represents a common logarithm of a viable count of fungi on the knitted fabric after 48-hour cultivation, and log T₀ represents a common logarithm of a viable count of fungi on the knitted fabric directly after inoculation.

3. The animal garment according to claim 1, wherein
the antifungal fibers are silver-containing fibers, and
the knitted fabric contains 2 mass % or more and 40 mass % or less of the silver-containing fibers.

4. The animal garment according to claim 3, having a content of silver contained in the silver-containing fibers of 0.01 parts by mass or more and 10 parts by mass or less relative to 100 parts by mass of the silver-containing fibers.

5. The animal garment according to claim 1, wherein
the knitted fabric contains 30 mass % or more and 95 mass % or less of cellulose-based fibers.

6. The animal garment according to claim 1, wherein
the knitted fabric has a moisture percentage in an environment of 25° C. and 60% RH of 3% or more and 15% or less.

7. The animal garment according to claim 1, wherein
the knitted fabric has a wale density of a skin-side surface of 30 wales/2.54 cm or more and 60 wales/2.54 cm or less.

8. The animal garment according to claim 1, wherein
the knitted fabric has a course density of a skin-side surface of 40 courses/2.54 cm or more and 80 courses/2.54 cm or less.

9. The animal garment according to claim 1, wherein
the knitted fabric includes spun yarns, and
each of the spun yarns includes the fibers having a single fiber fineness of 0.3 dtex or more and 1.1 dtex or less.

10. The animal garment according to claim 1, wherein
the knitted fabric contains 2 mass % or more and 20 mass % or less of elastic yarns.

11. The animal garment according to claim 1, wherein
the knitted fabric has, under a maximum load of 50 gf/cm, a tensile elongation in a body length direction or a body width direction of 10% or more and 150% or less.

12. An animal biological information measurement apparatus comprising:
the animal garment according to claim 1; and
a biological information measurement electrode provided on the animal garment.
